(19) United States
(12) Patent Application Publication
(10) Pub. No.: US 2004/0232898 A1
(43) Pub. Date: Nov. 25, 2004

(54) Power converter

(76) Inventors: Paul Morris, Gateshead (GB); Dexter Grant, New Malden (GB)

Correspondence Address: STITES & HARBISON PLLC, 1199 NORTH FAIRFAX STREET, SUITE 900, ALEXANDRIA, VA, 22314, US

(21) Appl. No.: 10/481,633

(22) PCT Filed: Jun. 27, 2002
(86) PCT No.: PCT/GB02/02948

(30) Foreign Application Priority Data
Jun. 29, 2001 (GB) 0116066.2

(51) Int. Cl. G05F 1/40

(52) U.S. Cl. 323/282

(57) ABSTRACT

A Power converter has a programmable component for controlling driving means for providing output power and an interface for receiving a power conversion topology and for programming the programmable component for controlling driving means for providing output power and an interface for receiving a power conversion topology and for programming the programmable component based on the received topology information. This enables an optimum power conversion topology to be implemented and to be updated according to requirements simplifying design and improving efficiency.

This invention relates to techniques of power conversion, and in particular aspects to the control of linear and switched mode power converters.

For many years, power processing and power conditioning circuitry and systems have used linear (analogue) techniques to regulate and control energy transfer. Typically, different power supply topologies require different power-supply control and drive schemes, with each topology requiring the development of a new controller. In addition, the economic costs, time and resources needed to develop and maintain a new converter, or to adapt an existing converter design, can be substantial. The response from the art has been to avoid this cost by making modifications to existing designs, often resulting in solutions that are far from ideal, and possibly reducing compatibility with new and emerging application markets.

In recent years switched mode power conversion has been used to reduce the size and weight of modern industrial, telecommunication and consumer electronic equipment. Digital technologies in commercial and consumer electronics have facilitated greater miniaturisation of electronic equipment, and generated new applications that require more complex power control. However, the changes in these new applications markets have created numerous problems for existing power converter technology. For example size (or “footprint”) and weight of power converters have remained high, reducing efficiency and preventing greater miniaturisation.

Furthermore, existing digitally controlled power conversion schemes are largely unable to resolve the conflicting requirements of performance, low-cost, flexibility and fast time to market. Conventional approaches employing DSPs, ASICs and FPGAs all force the system designer to forfeit at least one of these essential parameters.

Moreover, economics and environmental issues demand the better use of existing energy resources, much of which are lost in generation and transmission.

It is therefore an object of the present invention to address these problems, and to provide a more flexible power conversion scheme having greater efficiency. Accordingly, the invention consists in one aspect in a power converter having an input for receiving power, driving means for providing output power, a programmable component for controlling the driving means, and interface means for receiving power conversion topology information and for programming the programmable component based on the received information.

The invention thus provides a power supply “building block” capable of implementing software definitions of hardware functions which can be used for a variety of power supply topologies. This flexibility permits the architecture's use in a large variety of power supply schemes, as well as in schemes requiring multiple different conversion topologies, and negates the need for a replacement converter should supply requirements change. The architecture is thus more efficient, more adaptable and less complex than prior schemes.

In a further aspect, the programmable component comprises control means and a processor, wherein the control means is adapted to exert principal control over the driving means. Suitably, the processor is adapted to control the control means. Advantageously, the processor is adapted to program a power converter topology into the control means.

In this maimer, the processor is removed from the principal routing line through the conversion system. Thus, in contrast to prior converters, the processor is removed from direct control of the driving means, and merely “supervises” the power supply implementation. The processor is thus available for other applications, such as monitoring and troubleshooting within the system, and possible communication outside it This also produces greater efficiency, and also allows for a number of different applications which would be less practicable with prior converters under direct microprocessor control (if a non-dedicated microprocessor is used for both power conversion and other functions such as communication, power conversion may be degraded during communication).

Suitably, the control means comprises programmable logic means for implementing control algorithms and gating signals in order to drive the driving means, and interface means for operably communicating the control algorithms and gating signals to the driving means.

In this way, the converter may efficiently replicate the power conversion functions of prior converters in a more flexible system. The driving means may then be instructed according to the particular conversion topology currently being followed.

Preferably, the converter has an operating system programmed into a memory element. This allows simple and flexible programming of topologies into the device. Suitably, the driving means comprises a power actuator device, whose properties are alterable by means of an applied electrical signal, preferably a semi-conductor device.

Advantageously, the converter is connected to a power source. This permits the device to be used as a mediator between different power supply regimes, or to be implemented in an existing scheme, lending greater flexibility. The converter may also be used with a variety of driving devices, some of which may incorporate some form of power management.

Suitably, the converter is connected to a data network, and the processor is adapted to receive topology information from the data network.

In a preferred form of the invention, the driving means is replaceable. The converter is thus employable with any of a number of different driving devices. A core converter may also therefore be implemented in systems having greatly differing power requirements, as the principal requirement in such circumstances is for a different control schema, which the converter of embodiments of the invention may provide. In these circumstances, the power actuators required are typically also greatly different. In embodiments, the converter may comprise re-configurable power drivers. In further embodiments, the converter may be supplemented by additional jumpers or hard-wiring, in order that the change in control schema may be implemented satisfactorily by the power actuators used.

Suitably, the programmable element is adapted to be programmed once, and thereafter be non-configurable.

In a further aspect, the invention provides a power converter core comprising an interface for receiving power conversion topology information, an input for receiving power, and logic programmable to implement the topology information and output control signals for driving a power device.

In another aspect, the invention consists in a method of operating a power converter comprising the steps of receiving power conversion topology information over an interface of the power converter, configuring a programmable component based on the received information, and controlling a driving means to provide output power from an input source based on the received information.

Advantageously, the method comprises controlling the driving means with a control portion of the programmable component. Suitably, the control portion is controlled by a processor portion of the programmable component. Preferably, the processor portion is employed to program the control portion.

Preferably, the method comprises implementing in the programmable component control algorithms and gating signals to drive the driving means. Suitably, an interface is employed to communicate the algorithms and gating signals from the programmable component to the driving means.

Advantageously, the method comprises receiving information from a data network In a preferred application, the network may be the Internet

In a further aspect, the invention provides a method of creating a power converter comprising providing power converter hardware having power drive circuitry and a programmable component for generating the control signals required to drive the power drive circuitry; and subsequently programming the programmable component with power converter topology information. Preferably, the programmable component is programmed via an interface.

In another aspect, the invention provides a data structure comprising a set of parameters forming a power conversion topology programmable into a power converter having a programmable component. Preferably, the data structure is packaged to be downloaded via an interface, preferably from a data network, such as the Internet.

The invention also extends to a computer program or computer program product for carrying out any of the methods described herein.

The invention will now be described by way of example with reference to the accompanying drawings in which:

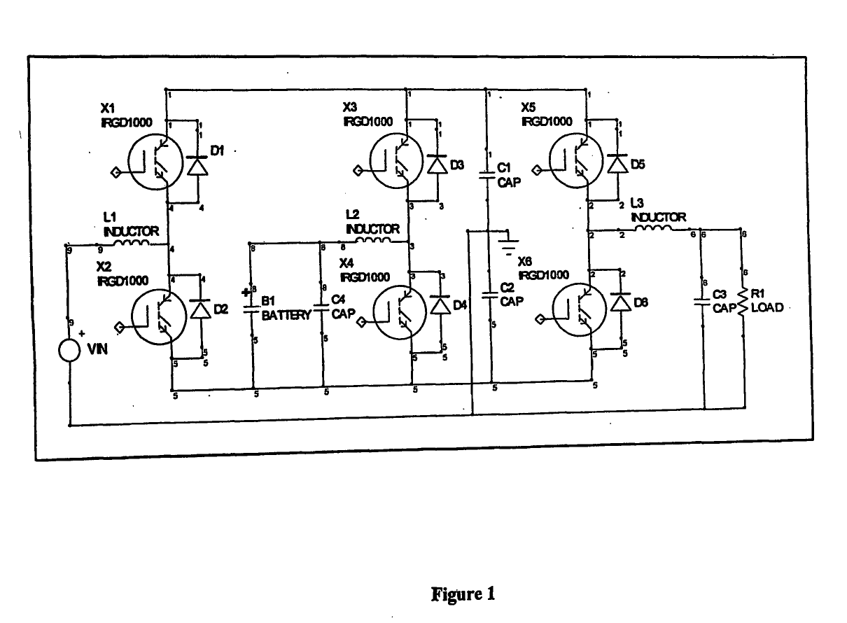

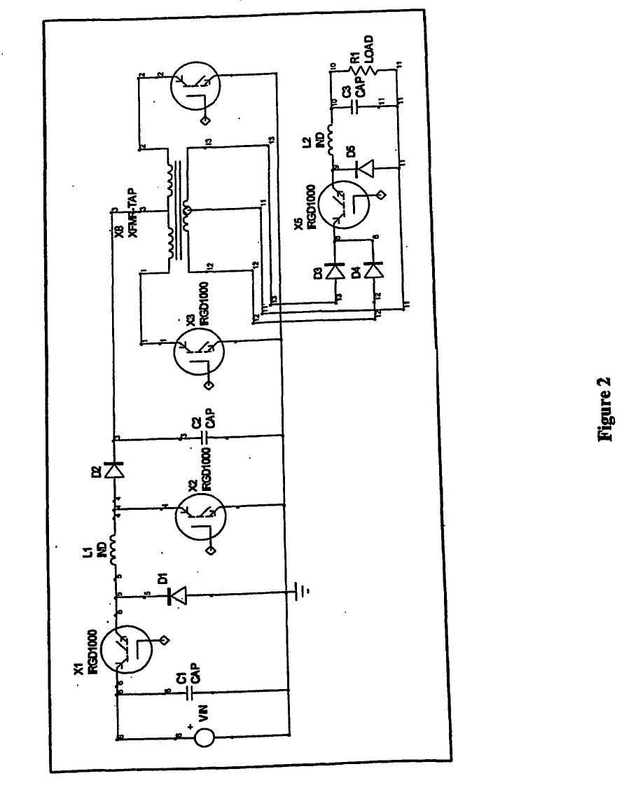

FIGS. 1 and 2 are diagrams illustrating multi-topology power conversion control schemas;

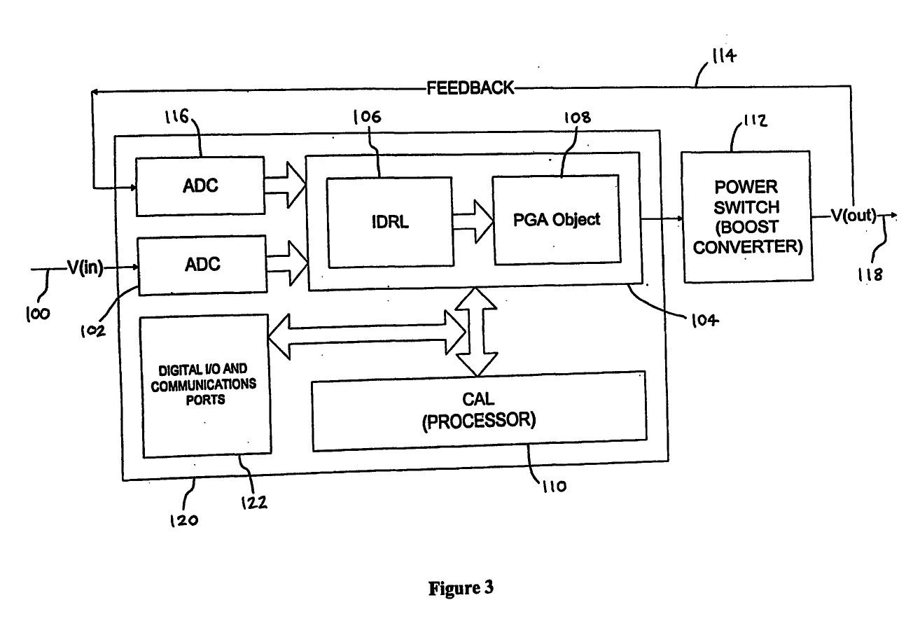

FIG. 3 is a diagram illustrating a power converter according to an embodiment of the invention;

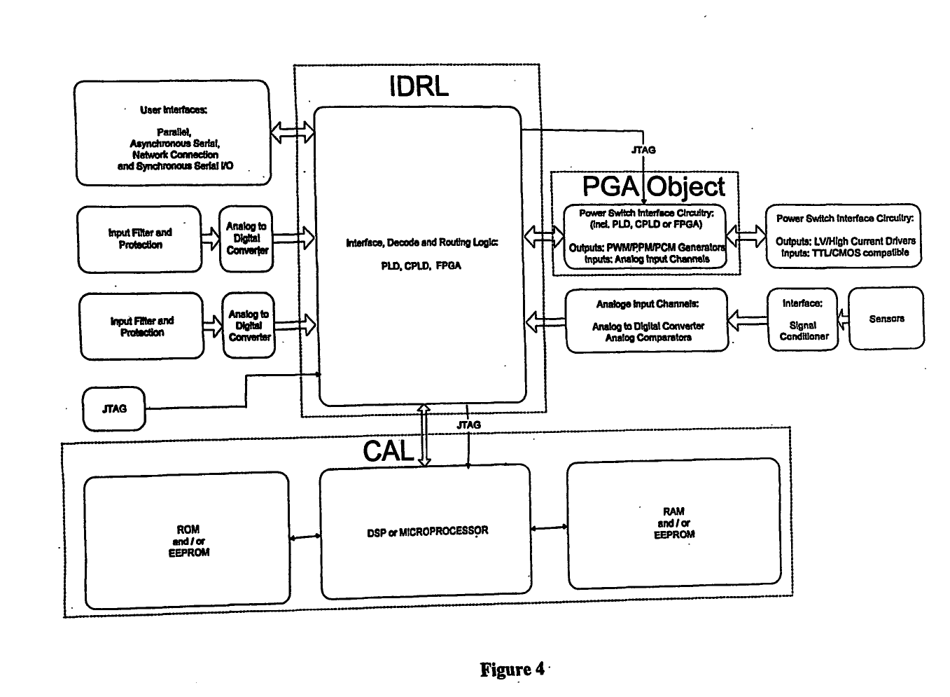

FIG. 4 is a diagram illustrating in detail hardware aspects of the power converter of FIG. 3;

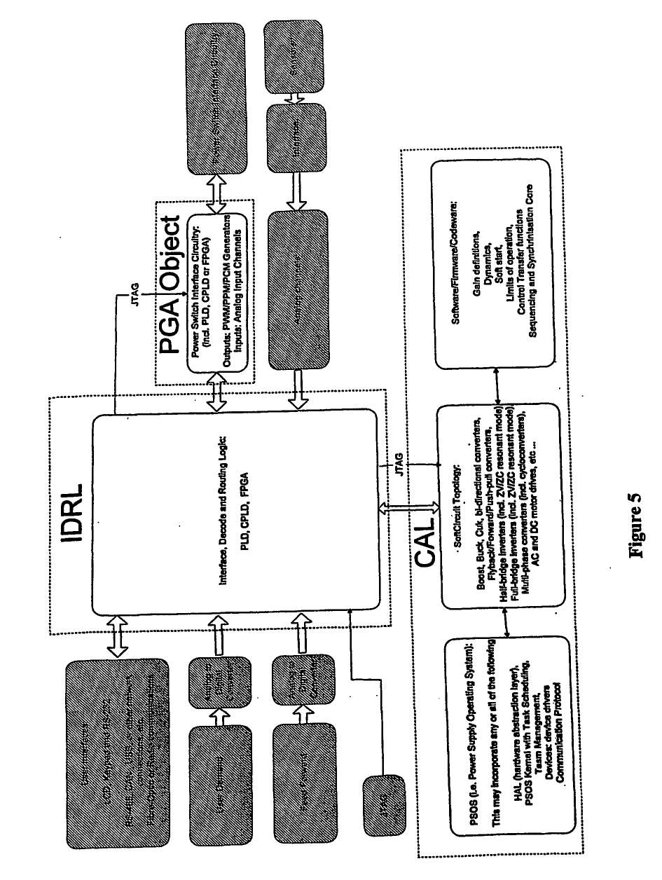

FIG. 5 is a diagram illustrating in detail software aspects of the power converter of FIG. 3;

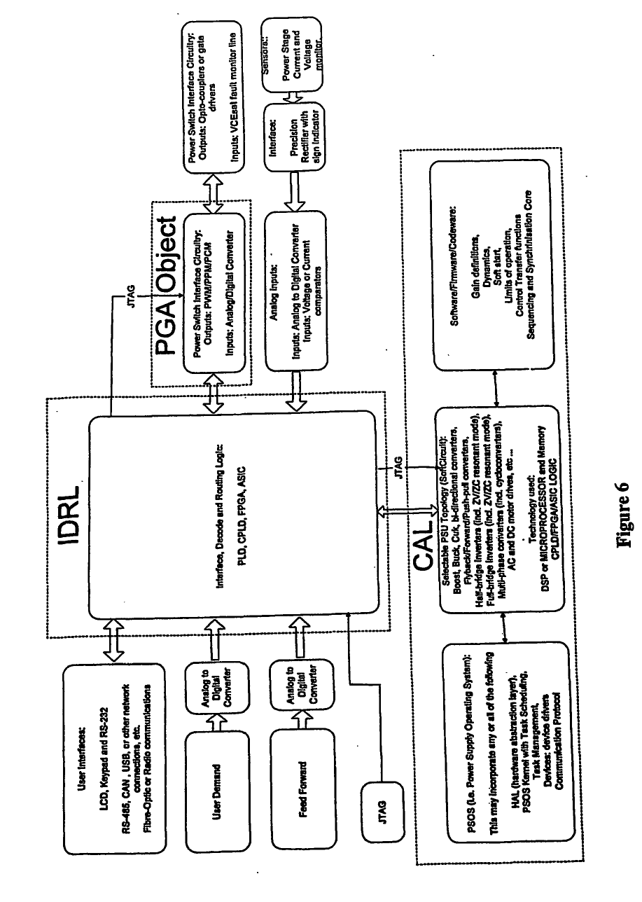

FIG. 6 is a combination of FIGS. 4 and 5;

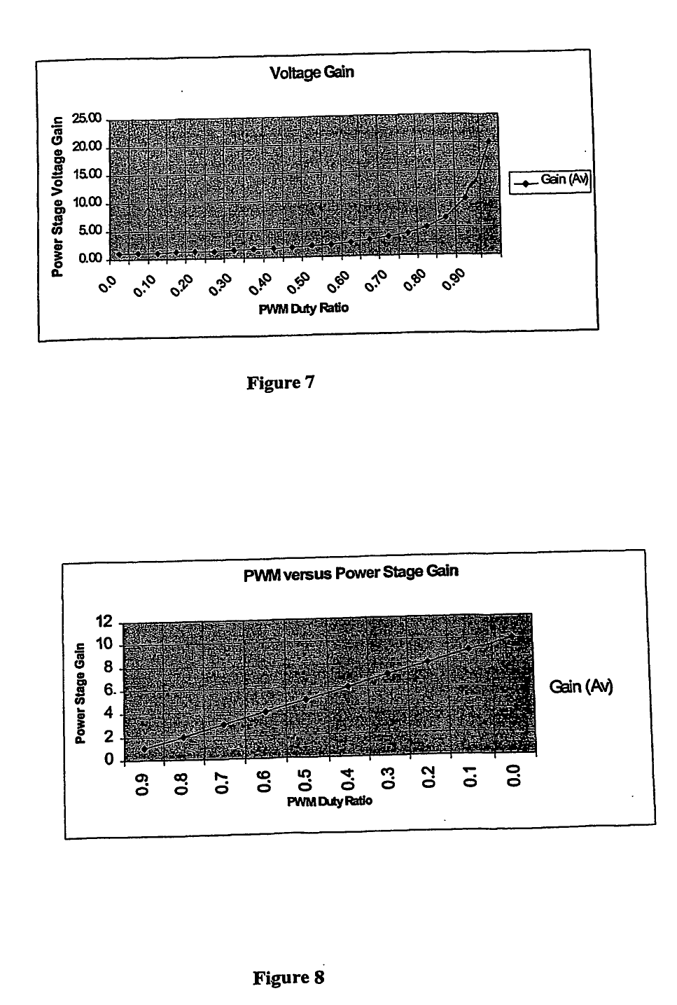

FIG. 7 is a graph illustrating the performance of a prior art converter,

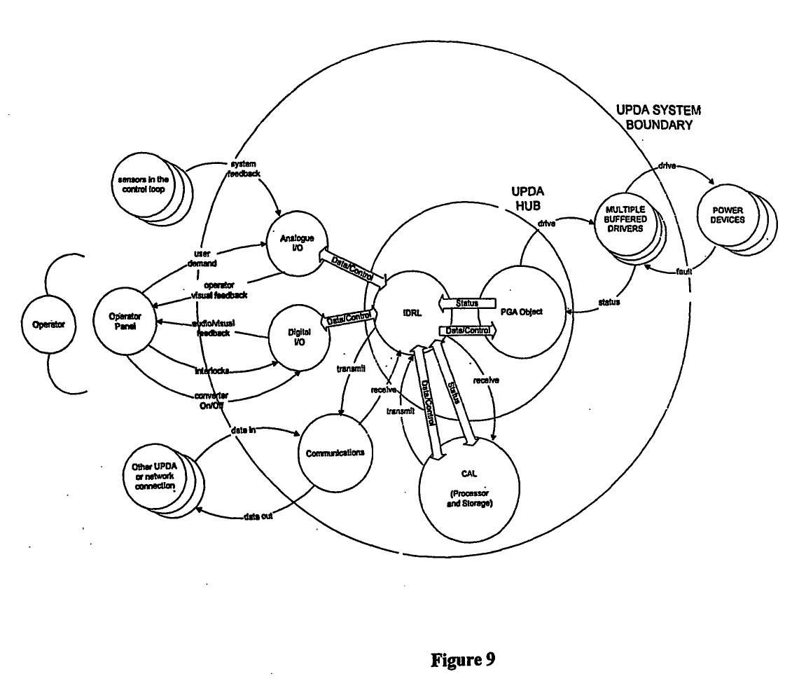

FIG. 8 is a graph illustrating the performance of a converter according to an embodiment of the invention;

FIG. 9 is a diagram illustrating systematically a power converter according to an embodiment;

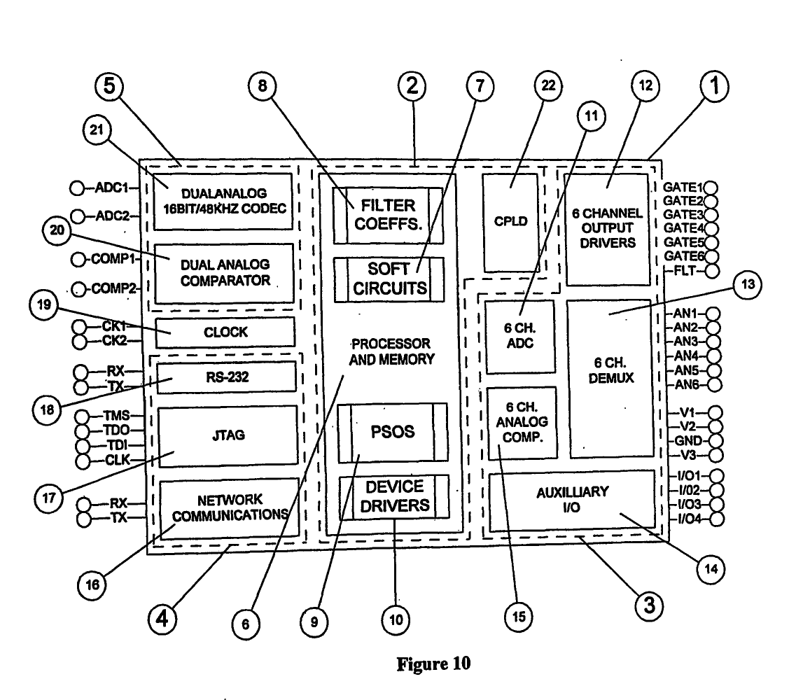

FIG. 10 is a diagram illustrating an intergrated circuit for power conversion according to an embodiment of the invention; and

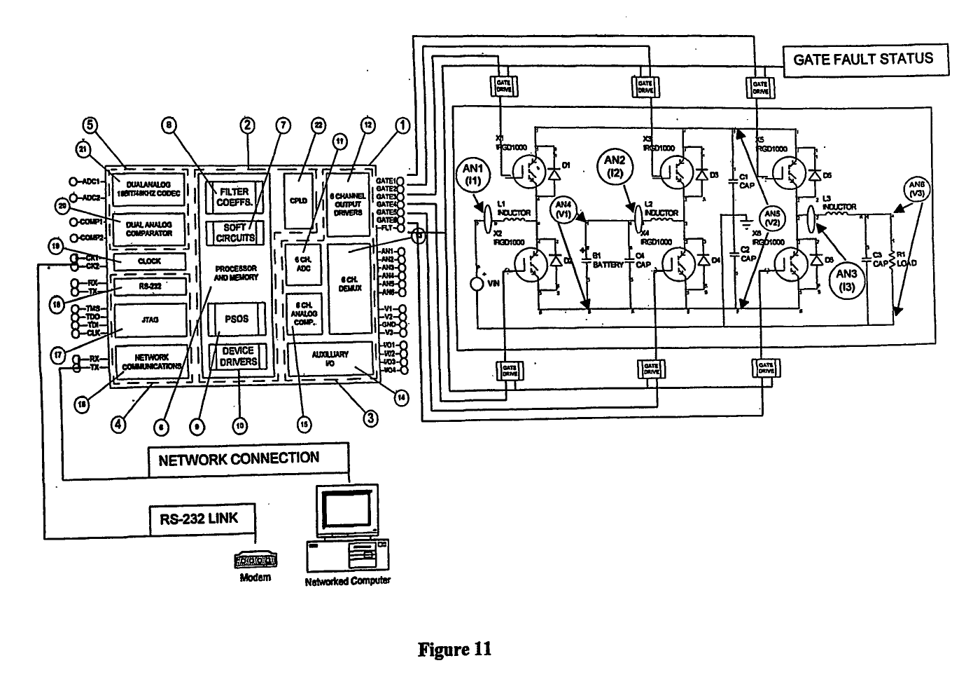

FIG. 11 is a diagram illustrating a circuit for power conversion according to a further embodiment of the invention.

Power converters are an essential yet invisible component for nearly all electrical and electronic systems, ranging from portable devices to huge power generators used on the national power grid. Numerous power converter topologies and control schemas have been developed to cope with the increasing demands of electrical and electronic applications. This is because each application sector (disparate examples of which include industrial lasers or Un-interruptable Power Supplies (UPS) used widely in computer and critical systems) requires different electrical control profiles in order to operate effectively.

Examples of such topologies or schemas include full and half-bridge converters, used in high powered laser systems, and boost and buck converters, used in UPS systems. Often, the demands of modern day applications can require a combination of three, four or more power converter control topologies to be used in a converter control schema in order to drive the application effectively. The requirement for using different converter control schemas is not limited to different application sectors, it also applies within the same application sector, where converter control schemas need to be modified to cater for the different power output levels. For example, a control schema developed to control a 1 kW industrial laser system may need to be modified in order to control a 20 kW laser.

Each schema is sufficiently different, not only to require different components, but also divergent control circuits and therefore different PCB manufacturing, verification and assembly processes. Furthermore, the more complex the control schema, the more costly it becomes, as the number of components used increases along with the size of the final power converter. Most, if not all, of the differences inherent within converter topologies are encapsulated within the control mechanism used to drive each converter control schema The power converter of embodiments of the invention is configurable to emulate a range of control mechanisms, in order to provide a desired topology.

FIGS. 1 and 2 illustrate two typical examples of multiple topology control schemas used within different applications. The control schema of FIG. 1 is typically used in an Un-interruptable Power Supply (UPS) application. It comprises an AC/DC. converter, Up/Down converter and a DC/AC inverter. FIG. 2's control schema is a typical DC/DC system, comprising a solid state switch, boost converter, push/pull converter, and a buck converter. DC/DC systems are widely used in solar power, telecommunication and motorized applications.

The power converter is connected to the power semiconductors and provides the control required for a particular topology, or combination thereof. Thus multiple topologies may be managed by a single configurable converter. Given the correct number of schemas, examples of which illustrated in FIGS. 1 and 2, the converter may produce any topology required by a particular architecture.

FIG. 3 shows the converter building block, or Unified Power Design Architecture (UPDA) (120) applied to a boost converter power supply using a single output driver power-switch channel. An input reference signal (100) is supplied to an analogue-to-digital converter (102), and the resulting digital signal is passed to the UPDA hub (104), the principal routing path. This comprises configurable logic (106) and an interface (108) for translating the digital signals into driving signals. The processes taking place in the hub (104) are overseen by and programmed from the processor (110). The signal from the UPDA then drives, in this case, the boost converter (112), to produce the required output power (118). Separate voltage and current feedback (114) is also input to the UPDA hub (104) via a second, typically multiple input, ADC (116). Typically, the connection between the UPDA and the driving means illustrated in FIGS. 1 to 3 is via opto-isolated gate drive interface circuits. Voltage and current feedback are accomplished using conventional voltage and current monitoring means.

By these means, the UPDA provides a common power supply building block, comprising macro/object style software definitions of hardware functions, that can be used in all power supply topologies. The Unified Power Design Architecture thus overcomes the problems of quickly developing power supplies by allowing the fabrication of a new converter from a library of power supply soft-circuit module definitions. The UPDA facilitates control loop parameters definition and updates, using a set of digital-filter coefficients. The filter coefficients, derived using digital signal processing theory, are stored in memory, which may be incorporated in the processor, or may be provided additionally. The configuration of the soft-circuit modules is retrieved from the memory via the processor and loaded into the programmable logic.

A principal benefit of using this approach where the processor is mainly responsible for housekeeping and other peripheral tasks, and not responsible for the core task of controlling the power actuators, is that most of the processor's capacity is available to provide for complex communication capability. This method of maintaining semi-autonomous control of the switching device, irrespective of the power converter scheme, may appear counter-intuitive. The prior method of implementing a digitally controlled converter is to use a dedicated microprocessor as the hub of the controller, here the hub is the IDRL and PGA Object. The advantage gained by this approach is that, for the most part, it is the configurable logic, rather than the processor, which determines the performance of the UPDA. This allows the UPDA to be considered for use in applications where previously microprocessor controllers were strictly disallowed. This is possible because the proportion of overall controller processes needed to perform a given power supply implementation which are under direct processor control are greatly reduced.

The invention addresses the conflicting requirements of performance, low-cost, flexibility, fast time to market, numerous and differing power supply topologies, control transparency and simplicity of implementation (normally requiring different control and drive schemes) by-the counter-intuitive step of removing the processor from the main control path of the controller, and shifting the control and regulation under the direct influence of the IDRL and PGA Object (the UPDA hub). The processor is instead used for algorithmic control, and parameter updating, network management and communications, providing the user interface, environmental monitoring and reporting or housekeeping. The IDRL and PGA Object are implemented using programmable logic (commonly found in digital computer circuits).

As power supplies are needed in all devices requiring a source of electricity, incorporation of the UPDA into any design may also yield the possibility that all electronic devices may have a common conversion platform. This would permit even greater efficiency in myriad devices, as well as greater cost efficiency in manufacture.

Other embodiments of the invention may incorporate a power supply operating system kernel to provide, for example, power supply power-processing, status reporting, undertake housekeeping tasks, and provide diagnostic support. Network management support (e.g. data packet routing) may also be provided, in order to afford still greater flexibility and functionality. Information such as communication profile (e.g. serial communications baud rate, packet filtering), manufacturer specific profile (e.g. manufacturers identity code), device function profile (e.g. profile describing exactly what the programmed device does), operation profile (e.g. operational limits), may also be provided, for ease of use and compatibility.

The invention is particularly suitable for linear and switched-mode power supply control by virtue of the provided analog input/output converter channels and the by virtue of the digitally generated pulse modulation capable outputs.

It should be noted that the converter is not limited to driving a single device, as depicted in FIG. 3. The UPDA hub may be employed with a variety of different driving devices for different purposes. For example, the UPDA may be employed in providing power for a 20 kW laser, or alternatively in, for example, a 600 W microwave oven. Typically, the power actuators required for these purposes will be very different in nature, but the UPDA's flexibility allows it to provide the control for either of these (and a range of other) systems. Essentially, the same UPDA may be used, though programmed with the correct topology for controlling the power device employed for the output required. The control signals programmed into the configurable logic will typically vary widely for different power drivers.

In embodiments, the converter may be applied to multiple output drivers and multiple power actuator devices. These may be employed simultaneously, or may remain unused until such tine as the requirements in a particular power conversion system are altered. The power actuators driven will typically be semiconductors (for example, MOSFETs, IRGDFETs, etc.), though it should be noted that the invention is not limited to these.

In further embodiments, further analogue and digital input/outputs are provided, in order to provide connection to various communication platforms. Particularly useful may be serial, parallel, optical, radio, or infra-red I/O, for example implementing Bluetooth™, SMS, IrDa, GPRS or other protocols. For example, the UPDA may receive a particular topology in the form of a software package delivered via a network.

This may be particularly applicable to the Internet, from which a particular UPDA might periodically retrieve, or be sent, updated topologies.

In certain embodiments, the multiple inputs and outputs available are employed in changing the directions of signals being routed through the converter. This permits the converter to alter the topology, along with the routing associated with, for example, feedback. Thus the converter may alter the hard routing, rather than simply altering the control of the power actuators, lending still greater flexibility.

FIG. 4 shows the hardware view; this view indicates the partitioned hardware features of the Unified Power Design Architecture. FIG. 5 shows the soft-circuit view; indicating the partitioned software elements. FIG. 6 shows the combined hardware and soft-circuit view. The elements shown in these figures will now be described in more detail.

The converter employs a means of acquiring data samples from an analogue signal; in this case, a sampling analogue to digital converter. Alternatively a sampling signal processor may be used in order to allow amplitude scaling or filter coefficient specification and updating, and/or provide a means for digital filtering of a signal. The analogue to digital converter sampling frequency is preferably derived from the converter's (and therefore the controller's) operating frequency and may be set to multiples or sub-multiples of the converter's operating frequency.

The analogue to digital sampling intervals are preferably set to coincide within a time interval when the power devices are at a quiescent point in their switching interval (e.g. not during a power switch transition). This is done to ensure that low level signals (relative to the levels of power being switched) being monitored are not influenced by power switching noise. The analogue to digital converter channels may additionally include sample and hold amplifiers. The ADC sample frequency may be set to twice the highest bit rate available (in the case of an n-bit synchronous counter) and centre aligned. By so doing the ADC will reject any power actuator induced noise.

In an embodiment, the programmable/re-programmable logic of the UPDA hub is configured to provide a digitally modulated signal, typically Pulse Width Modulated (PWM), Pulse Position Modulation (PM), Pulse Code Modulation (PCM) or state machine generated outputs.

By selecting a suitably high sampling rate (for example, 2 to 1000 times the power converter switching frequency), it is possible to achieve higher resolutions of PWM, PPM and PCM digitally modulated gating signals. This may be achieved in the case of PWM operation, for example, by using the ADC in ‘comparator mode’ to terminate the otherwise low resolution PWM output, thus giving a higher level of granularity in the control of a PWM channel. A fast analogue comparator channel may also be used for this purpose.

The IDRL (Interface, Decode and Routing Logic) provides the internal routing, interface and decode logic for all digital signals within the UPDA controller, and comprises a programmable logic array. To maintain control and regulation of the converter output without microprocessor intervention, the IDRL routes data and control information directly between the analogue I/O, digital I/O and the power actuator drivers, specifically bypassing the microprocessor. The IDRL performs the required power processing via specially programmed re-programmable hardware MAC (multiply and accumulate) registers, using multiplier coefficients which are uploaded from the processor, and may also be requested from the processor by the IRDL in certain circumstances. Default values for the multiplier coefficients can be stored in memory and retrieved without microprocessor intervention. A special request for multiplier-coefficient updates can be generated by the IDRL to the processor if the output regulation performance deviates beyond pre-defined tolerance bands.

The IDRL is also responsible for monitoring the status of the converter and reporting the status to the CAL microprocessor. There are also provided digital interfaces to externally connected peripherals such as displays, keypads input and communication physical layers (e.g. CAN, RS-232, Ethernet, USB, fibre-optic or Radio communication interface, and other communication connections).

The PGA Object (Power Gateway Architecture Object) provides the hardware interface to the power actuators. In all cases, the PGA Object incorporates a process, which will accept a continuously varying or static n-bit wide digital values (in either serial or parallel form) at its input and translate it into either linearly varying (or possibly non-linearly varying) digitally modulated output such that the overall power converter open loop transfer function of the complete converter can be linearised. A region of memory (which can be either volatile or non-volatile) may be allocated for the storage and retrieval of look-up table data which is used to linearise the loop gain transfer function. For example, in the case of a boost converter, it can be shown that a linear variation in PWM at the input to the switching device will result in a non-linear change in the output voltage of the converter. This variation in gain can make it difficult to optimize dynamic performance of such a converter, particularly as there is more than one factor which typically modifies the loop gain of these systems (e.g. input supply voltage, PWM gain non-linearity, internal voltage drops, and supply impedance). FIG. 7 shows the typical non-linear performance of a conventional PWM controlled boost-converter.

FIG. 8 in contrast shows the typically linear performance of a simple UPDA implemented-PWM controlled boost converter. In this case, the PWM output is directly modulated, by the level of the input supply voltage (using a direct-digital feed-forward term), and without micro-processor intervention. In this case the PWM is inversely proportional to the input supply.

The CAL (Control Abstraction Layer) works in conjunction with, and is used to program, the IDRL and PGA Object. For example a three phase motor drive would require a different number and configuration of power switch channels, when compared to say, a two stage converter comprising a first stage boost converter and a second full-bridge inverter. In both cases, the routing of gating signal from the input side of the

IDRL to the PGA Object might need to be different. The CAL is used to directly program or facilitate the programming of the new routing, and at the same time program the new transfer function for the PGA Object into the PGA Object translation registers. In the case of the PGA Object, for example, when programming a new or blank device, the CAL retrieves information from memory which defines the input/output transfer function between the PGA Object input and the PWM/PCM/PPM at its output for a selected topology. The CAL calculates algorithmically the values that would need to be programmed into the PGA Object translation table to linearise the PGA Object transfer function. The CAL then writes those values into the PGA Object translation table.

The CAL is also used to monitor and maintain the performance of the power converter by dynamically updating the DRL MAC (multiply and accumulate) digital filter coefficients. Default values for the multiplier coefficients can be stored in memory and retrieved without microprocessor intervention. A special request for multiplier-coefficient updates can be is generated by the IDRL and received by the CAL processor if the output regulation performance deviates beyond pre-defined tolerance bands. The CAL then monitors the system performance and calculates new multiplier coefficients and sends them to the IDRL upon completion of the calculation of a new set of multiplier-coefficients. The CAL is also responsible for reporting the status of the converter to the operator and to other systems connected over the digital I/O and/or network communication channels.

The CAL incorporates a High Layer Protocol which is used to establish process related data connections (for example, in the case of multiple converter system configurations), provide network management, exchange process data, provide fault management, store communication profile information, manufacturer specific details, (e.g. manufacturers name, device name) operation profile (e.g. provide network management, provide intermodule communications, provide a mechanism for adaptive control algorithms, and data exchange and communication protocol implementation. The CAL also incorporates and maintains a logical and physical devices identifier that comprises at least one bit or more in length.

The CAL comprises key utility operations of the converter (e.g. digital filtering, loop compensation and gain, and general power management tasks). Additionally the CAL may also provide a means of permitting fuzzy-logic type performance enhancements, perhaps based on operational temperatures, output load and input supply conditions.

A clock oscillator is preferably incorporated into the system, to provide a free running reference system clock. For example, a digital phase locked-loop (DPLL) clock oscillator may be used in order to facilitate synchronization with an: external clock reference.

The system employed will typically use a programming language as the interface between user instruction and the topology to be implemented in the UPDA hub. In an embodiment, the memory elements in the CAL will store software for the interpretation of the instructions input into the UPDA via the various possible user interfaces. The language used to define the circuit topology will typically be a Hardware Definition Language (HDL). In one embodiment, a communication protocol is established between the interface and the user, in order to a permit interaction at a higher level than simple direct programming of the UPDA hub. For example, the CAL may be programmed with an operating system, such as a Linux kernel, in order to manage and/or derive the user-to-topology interface. The operating system may interpret particular forms of input, thus allowing the user to enter topologies to be used in various ways. For example, the user could stipulate certain parameters, which the system would interpret to produce a topology, or the user might construct a topology on a graphic interface, which would then be interpreted and implemented.

FIG. 9 is a schematic diagram of the Unified Power Design Architecture, incorporating the elements described above.

FIG. 10 illustrates an example of a UPDA integrated circuit according to an embodiment of the invention. This implementation can be used for power converters using up to 6 power switch devices (i.e. one power switching device on each of the six power digitally modulated switch channels). The IC comprises the circuitry to implement algorithmic power-processing and soft-circuit definition of the UPDA and facilitate the necessary communication, implemented using a microprocessor or digital signal processor (6), and configurable logic (22) to facilitate soft-circuit definitions, power-device sequencing and power-gating. Analogue interfaces (5) and (13) are provided for monitoring and control. A general purpose interface (14), decode and control and data path routing logic (22), network and communications connections (4), memory (6) to store filter coefficients (8) and software definitions (7, 9, 10) of hardware functions are also integrated.

FIG. 11 illustrates a circuit according to an embodiment of the invention, wherein the UPDA circuit of FIG. 10 is implemented with the power circuit illustrated in FIG. 1. As shown, network connections may be applied, for example to monitor the UPDA, or to supply topology information. The gate fault status may also be monitored, as shown, for example, by a user through an interface, or by the processor overseeing the functions of the UPDA.

The Unified Power Design Architecture can radically alter the economic and technological landscape of power conversion, heralding a whole new generation of intelligent power converters and move power electronics into alignment with other technologies such as microelectronics. In particular, the UPDA system allows substantial reduction in size and weight of power conversion devices, is more energy efficient than prior designs, and is highly flexible. Further advantage is gained from the ability to produce unity Power Factor Conversion, and the architecture may be applicable on a large range of systems, typically from Watts to Megawatts.

Technologically, UPDAs can facilitate superior energy efficiency and better controllability. Furthermore the complexity of managing multiple power converter topologies may be greatly simplified. The technology has the potential to derive substantial economic benefits due to faster application development and streamlined manufacturing processes leading to lower development and manufacturing costs. These in turn may increase the chances of successful deployment of new power supply applications under increasing time-to-market pressures and decreasing product life-cycles.

It will be appreciated by those skilled in the art that the invention has been described by way of example only, and that a wide variety of alternative approaches may be adopted without departing from the scope of the invention. In particular, the UPDA has been applied to examples involving certain converters, though it should be appreciated by the skilled reader that any power conversion device may be employed with the architecture described. Embodiments of the design may support more or fewer output driver power-actuator channels, in order to allow for greater flexibility.

1. A power converter having an input for receiving power, driving means for providing output power, a programmable component for controlling the driving means, and interface means for receiving power conversion topology information and for programming the programmable component based on the received information.

2. A converter according to claim 1, the programmable component comprising control means and a processor, wherein the control means is adapted to exert principal control over the driving means.

3. A converter according to claim 2, wherein the processor is adapted to control the control means.

4. A converter according to claim 2 or claim 3, wherein the processor is adapted to program a power converter topology into the control means.

5. A converter according to claim 1, wherein the control means comprises programmable logic means for implementing control algorithms and gating signals in order to drive the driving means.

6. A converter according to claim 5, wherein the control means comprises interface means for operably communicating the control algorithms and gating signals to the driving means.

7. A converter according to claim 1, further comprising a memory element, and wherein an operating system is programmed into the memory element.

8. A converter according to claim 1, wherein the driving means comprises a power actuator device, whose properties being alterable by means of an applied electrical signal.

9. A converter according to claim 8, wherein the power actuator device comprises a semi-conductor device.

10. A converter according to claim 1, wherein the converter is connected to a power source.

11. A converter according to claim 1, wherein the converter is connected to a data network.

12. A converter according to claim 11, wherein the processor is adapted to receive topology information from the data network.

13. A converter according to claim 1, wherein the driving means is replaceable.

14. A converter according to claim 1, wherein the programmable element is adapted to be programmed once, and thereafter be non-configurable.

15. A power converter core comprising an interface for receiving power conversion topology information, an input for receiving power, and logic programmable to implement the topology information and output control signals for driving a power device.

16. A method of operating a power converter comprising the steps of receiving power conversion topology information over an interface of the power converter, configuring a programmable component based on the received information, and controlling a driving means to provide output power from an input source based on the received information.

17. A method according to claim 16, comprising controlling the driving means with a control portion of the programmable component.

18. A method according to claim 17, comprising controlling the control portion with a processor portion of the programmable component.

19. A method according to claim 17, comprising employing the processor portion to program the control portion.

20. A method according to claim 17, comprising implementing in the programmable component control algorithms and gating signals to drive the driving means.

21. A method according to claim 20, comprising employing an interface to communicate the algorithms and gating signals from the programmable component to the driving means.

22. A method according to claim 16, comprising receiving information from a data network.

23-28. (Canceled)
